(19) United States
(12) Patent Application Publication
(10) Pub. No.: US 2004/0129691 A1
(43) Pub. Date: Jul. 8, 2004

(54) Flexible cover for protecting welded electrode holders

(76) Inventors: Douglas Brent McTavish, Campbell River (CA); Robert Gordon Metheral, Parksville (CA)

Correspondence Address: DAVID R PRESTON & ASSOCIATES, 12625 HIGH BLUFF DRIVE, SUITE 205, SAN DIEGO, CA, 92130, US

(21) Appl. No.: 10/336,509

(22) Filed: Jan. 3, 2003

(51) Int. Cl. B23K 9/28

(52) U.S. Cl. 219/138

(57) ABSTRACT

There is provided a flexible cover for protecting a welded electrode holder, which comprises an elongate arceol hollow body; a protrusion extending outwardly from a lower side of the body; and a lip extending inwardly around the border of at least one aperture of the body. Upon mounting the cover on a welded electrode holder, the cover flexes and adopts the shape of the holder and the lips engages an external circumference of the holder.

### FIELD OF THE INVENTION

The present invention relates generally to covers for protecting delicate structures such as welded parts of an equipment. Particularly, the invention relates to covers for welded electrode holders. More particularly, the invention provides a cover or protector for an arc welded head.

### BACKGROUND OF THE INVENTION AND PRIOR ART

Equipment of an industrial site always comprises arc welded heads. These heads are generally very delicate structures, as they can easily be cracked or broken. In addition, the arc welded heads may present a danger for people working on an industrial site, in the sense that when a head is damaged, an operator manipulating it can receive an electrical shock. Also, when a damaged head comes into contact with another material, there is a possibility of causing sparks or fire. The operator can also be subjected to an electrical shock when the working environment is wet.

In order to prevent an operator from receiving an electrical shock from a cracked arc welded head, this latter is generally simply thrown away arid replaced by a new one. Needless to mention that this process is quite expensive, as arc welded heads are susceptible of being cracked or broken quite easily.

Sometimes when dealing with a minor crack, a temporary repair is undertaken, by wrapping the damaged head with a tape. However, because of the rough existence of the equipment on an industrial site, the tape becomes very quickly worn, thus leaving the damaged head unprotected. On the other hand, the operator does not always feel secure at the sight of such a repair made with a tape, knowing how easily the tape can be torn away.

There is therefore a need for a device for preventing an arc welded head from cracking or breaking. There is also a need for a device allowing for an efficient repair to a damaged head.

### SUMMARY OF THE INVENTION

It is an object of the present invention to provide a cover for protecting an arc welded head on an industrial site or for protecting an operator from the danger of a damaged welded electrode holder.

It is a further object of the present invention to provide an efficient way to temporarily repair a damaged arc welded head.

The present invention, from one aspect provides a flexible cover for protecting a welded electrode holder comprising: an elongate arced hollow body having opposed first and second open ends each defining an aperture, the body being defined by an upper side, a lower side and opposed lateral sides; and a protrusion extending outwardly from the lower side; wherein upon mounting the cover on a welded electrode holder, the cover flexes and adopts the shape of the holder.

According to a further aspect, the invention provides a flexible cover for protecting a welded electrode holder comprising: an elongate arced hollow body having opposed first and second open ends each defining an aperture, the body being defined by an upper side, a lower side and opposed lateral sides; a protrusion extending outwardly from the lower side; and a lip extending inwardly around the border of at least one of the apertures and substantially perpendicularly to the border; wherein upon mounting the cover on a welded electrode holder, the cover flexes and adopts the shape of the holder and the lip engages an external circumference of the holder.

In a preferred embodiment of the flexible cover according to the invention, a lip can extend invariably around the boarder of at least one of the apertures and substantially perpendicularly to the boards, in such a way that when the lip engages an external circumference of the holder. More preferrably, the body of the cover and the protrusion may form a visually unitary structure.

In another preferred embodiment, the cover can be made of a flexible material which has sufficient rigidity and thickness to maintain a defined shape when not in use, and to adopt the shape of the welded electrode holder when mounted thereon. The flexible material can be rubber, latex or leather, and may have a bright colour.

In yet another preferred embodiment, the cover may have a length of about 6 cm to about 8 cm, a height of about 4 cm to about 7 cm and a width of about 3 cm to about 5 cm.

The present invention, from another aspect provides a method of protecting a damaged welded electrode holder comprising mounting the cover according to the invention on said holder.

Directional references within present specification and claims refer to terms such as “upper”, “lower”, “up”, “down” and the like. These references are for convenience of description only, as it will be understood that the device according to the present invention may be positioned in any orientation. Directional references refer to the device when positioned generally vertically, with the outwardly oriented protrusion extending downwardly, one aperture of the device being oriented downwardly and the other aperture being side oriented.

The term “semi-rigid” as used herein means sufficient rigidity to maintain a given position when not in use, but when mounted on an arc welded head, the device flexes and adopts the shape of the head.

Other features and advantages of the present invention will become apparent from the following detailed description of the preferred embodiment of the invention with reference to the accompanying drawings.

### BRIEF DESCRIPTION OF THE DRAWINGS

FIG. 1 is a perspective view of the welded electrode holder protector;

FIG. 2 is a perspective view of the welded electrode holder protector mounted on an arc welded head;

FIG. 3 is a cross-sectional view of the welded electrode holder protector taken along line 3 of FIG. 1;

FIGS. 4 and 5 are side views of the welded electrode holder protector;

FIG. 6 is a bottom view of the welded electrode holder protector; and

FIG. 7 is a rear view of the welded electrode holder protector.

While the invention will be described in conjunction with the illustrated embodiment, it will be understood that it is not intended to limit the invention to this embodiment only. On the contrary, it is intended to cover all alternatives, modifications and equivalents as may be included within the spirit and scope of the invention as defined by the appended claims.

### DESCRIPTION OF THE PREFERRED EMBODIMENT

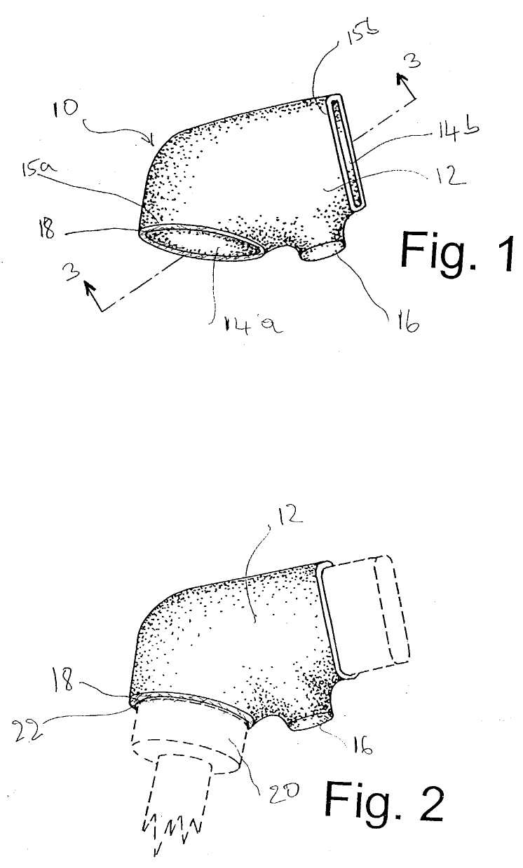

A perspective view of the protector or cover 10 according to the invention is illustrated in FIG. 1. As seen in the Figures, the cover is of a relatively parallelepipedic shape, with a hollow interior. The cover comprises an elongate body 12, made of a flexible skin. The body has open first and second ends 15a and 15b which define apertures 14a and 14b. The body also has an upper side, a lower side and opposed lateral sides, bearing in mind the above-mentioned reference to the orientation of the cover. The body is arced downwardly at a portion next to the first end 15a, and a protrusion 16 extends outwardly from the lower side of the cover, at a portion next to the second end 15b. Thus, it can be seen the protrusion extends downwardly. The body 12 and the protrusion 16 together form an integral and visually unitary structure, with a continuously curving exterior surface. A lip 18 extends inwardly and perpendicularly from the skin, all around the border of the first aperture 14a. The lip provides a sealing function, since it contacts the exterior surface of the welded electrode 20 around its circumference 22, as best seen in FIG. 2. A similar lip can also be provided around the boarder of the second aperture 14b.

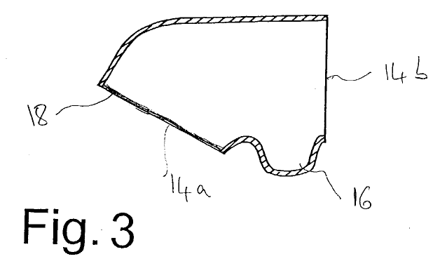

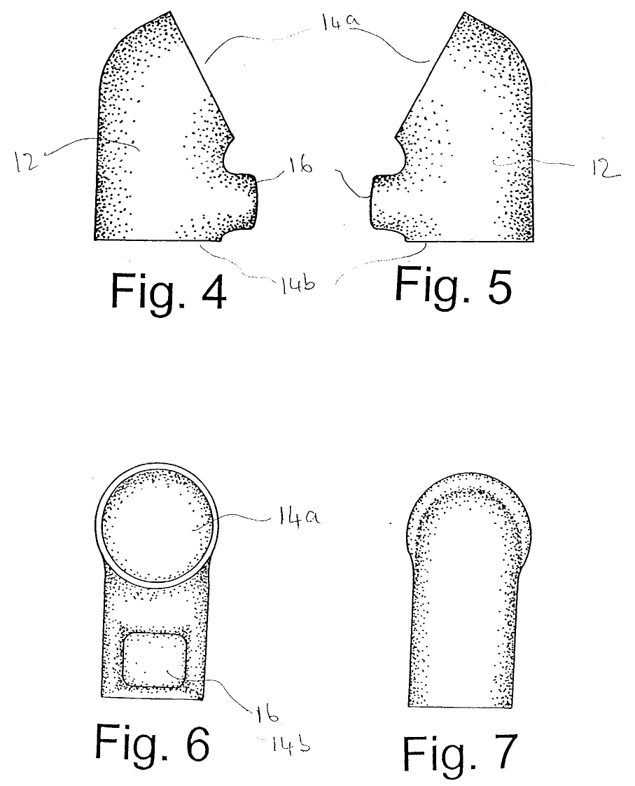

The overall configuration of the cover is relatively elongate. In elongate cross section, as illustrated in FIG. 3, the cover has the configuration resulting from joining the respective ends of an upper curved line and a lower curved line by straight lines. The upper and lower sides of the body constituting respectively the upper and lower curved lines, and the first and second ends of the body constituting the straight lines. The forgoing configurations represent illustrative configurations for the present invention. It will be seen that these configurations may change depending on the shape of the welded electrode to be protected. By way of a non-limiting example, the arc of the body may be more or less pronounced, and the shape of the protrusion may as well varied.

The preferred overall dimensions of the cover or protector are about 6 cm×5 cm×3 cm (length, height, width). These dimensions represent an illustrative size only, and are not intended to limit the scope of the invention. Indeed, the cover according to the present invention may be manufactured in any convenient size. By way of non-limiting example, the length of the cover may range between 6 and 8 cm, the height may range between 4 and 7 cm and the width may range between 3 and 5 cm.

The cover or protector of the present invention can be made of a range of flexible materials having sufficient rigidity and thickness to maintain its shape when not in use, and adopt the shape of the arc welded head when mounted thereon. The material should also be insulating. Preferably, the material of the cover according to the invention may be of bright color so that heads can be easily visually located among other parts and installations on an industrial site. A non-limiting list of examples includes natural or synthetic rubber, latex, leather or a suitable plastic. A suitable thickness range is about 1 to 3 mm, with a preferred range being about 1.5 to 2 mm.

Variations within the scope of the present invention will be apparent from the described embodiment and it is intended that the present description is merely illustrative of the inventive features encompassed by the appended claims.

We claim:

1. A flexible cover for protecting a welded electrode holder comprising:
an elongate arced hollow body having opposed first and second open ends each defining an aperture, said body being defined by an upper side, a lower side and opposed lateral sides; and
a protrusion extending outwardly from said lower side;
wherein upon mounting said cover on a welded electrode holder, said cover flexes and adopts the shape of said holder.

2. A cover as defined in claim 1, further comprising a lip extending inwardly around the border of at least one of said apertures and substantially perpendicularly to said border, wherein upon mounting said cover to the welded electrode holder, said lip engages an external circumference of said holder.

3. A cover as defined in claim 1, wherein said body and said protrusion form a visually unitary structure.

4. A cover as defined in claim 1, wherein said cover is made of flexible material having sufficient rigidity and thickness to maintain a defined shape when not in use, and to adopt the shape of the welded electrode holder when mounted thereon.

5. A cover as defined in claim 4, wherein said flexible material is selected from rubber, latex and leather.

6. A cover as defined in claim 1, wherein said cover has a bright color.

7. A flexible cover for protecting a welded electrode holder comprising:
an elongate arced hollow body having opposed first and second open ends each defining an aperture, said body being defined by an upper side, a lower side and opposed lateral sides;
a protrusion extending outwardly from said lower side; and
a lip extending inwardly around the border of at least one of said apertures and substantially perpendicularly to said border;
wherein upon mounting said cover on a welded electrode holder, said cover flexes and adopts the shape of said holder and said lip engages an external circumference of said holder.

8. A cover as defined in claim 4, wherein the thickness of said flexible material is about 1 to 3 mm.

9. A cover as defined in claim 4, wherein the thickness of said flexible material is about 0.5 mm.

10. A cover as defined in claim 1 having a length of about 6 cm to about 8 cm.

11. A cover as defined in claim 1 having a height of about 4 cm to about 7 cm.

12. A cover as defined in claim 1 having a width of about 3 cm. to about 5 cm.

13. A cover as defined in claim 1 having a length of about 6 to 8 cm, a height of about 4 to 7 cm and a width of about 3 to 5 cm.

14. A method of protecting a damaged welded electrode holder comprising mounting the cover as defined in claim 1 on said holder.
